(19) United States
(12) Patent Application Publication
(10) Pub. No.: US 2026/0316220 A1
(43) Pub. Date: Oct. 15, 2026

(54) GRINDING SYSTEM FOR GRINDING A SURFACE OF A METAL PRODUCT

(71) Applicants: DANIELI & C. OFFICINE MECCANICHE S.P.A., Buttro (IT); DANIELI AUTOMATION S.P.A., Buttrio (IT)

(72) Inventors: Paolo PAPINUTTI, Buttrio (IT); Ignacio GIUNTA, Buttrio (IT); Francesco ZARAMELLA, Buttrio (IT)

(21) Appl. No.: 19/475,609

(22) PCT Filed: Apr. 23, 2024
(86) PCT No.: PCT/IB2024/053934

§ 371 Date: Oct. 15, 2025

(30) Foreign Application Priority Data
Apr. 26, 2023 (IT) 102023000008136

(51) Int. Cl. B24B 49/12; B24B 5/38; B24B 51/00

(52) U.S. Cl. CPC B24B 49/12; B24B 5/38; B24B 51/00

(57) ABSTRACT

A grinding system for grinding a surface of a metal product, in the form of a billet or slab, the system comprising a grinding wheel (1), adapted to remove in each grinding pass a respective longitudinal portion of a surface layer of the metal product during a relative movement between the metal product and said grinding wheel along a plane; positioning means (2, 3) for the grinding wheel (1) adapted to keep said grinding wheel (1) in contact with the surface of the metal product during each grinding pass; wherein at least one sensor (4, 4′) is provided, adapted to detect the profile of the longitudinal portion of surface layer to be removed during each grinding pass; and wherein a control device (5) is provided adapted to memorize said profile and configured to control the positioning means (2, 3) so that the grinding wheel (1), during a subsequent grinding pass for removing a further longitudinal portion of said surface layer which is adjacent to the longitudinal portion removed in the previous grinding pass, moves perpendicularly to said plane to follow said profile detected in the previous grinding pass.

### CROSS-REFERENCE TO RELATED APPLICATIONS

This application claims priority to PCT International Application No. PCT/IB2024/053934 filed on Apr. 23, 2024, which claims priority to Italian Patent Application No. 102023000008136 filed on Apr. 26, 2023, the entire disclosures of which are expressly incorporated herein by reference.

### STATEMENT RE: FEDERALLY SPONSORED RESEARCH/DEVELOPMENT

Not Applicable

### BACKGROUND

### 1. Field of the Invention

The present invention relates to a grinding system for grinding a surface of a metal product, in the form of a billet or a slab, and to a related grinding process.

### 2. Background Art

In the sector of rolling semi-finished metal products, grinders are used inside rolling mills to remove surface defects (e.g., cracks, burrs, slag, etc.) through a process of controlled material removal by means of a grinding wheel, or simply grinder, applied to a mechanical structure.

This mechanical structure is hinged on a point, which is called the fulcrum, which defines the oscillation axis thereof. In this case the mechanical structure is known as a grinding pendulum.

The grinder is kept rotating at a constant speed by a motor connected to a mandrel whose shaft is aligned with the rotation axis of the grinder.

It is the object of the processing to remove a thin and uniform layer of material with a thickness of a few tenths of a millimeter, up to a few millimeters, from the surface of the semi-finished metal products, such as steel billets or slabs, going after any geometric irregularities of the surfaces so as to eliminate surface defects and increase the quality of the product.

The basis of the process is the adjustment of the motor torque, which keeps the speed of rotation of the grinder constant by controlling the movement of the grinding pendulum obtained by means of a hydraulic system consisting of a double-acting cylinder and a proportional valve.

The increase in the force imparted by the cylinder causes an increase in the friction forces in the grinder-material contact which has repercussions on the grinding torque and the thickness removed, causing them to increase.

The torque reference is determined on the basis of an empirical law which takes into account a large number of factors including: temperature and features of the material, feeding speed of the material.

The complexity of the system, mainly due to
the presence of components with highly non-linear behavior, such as, for example, the proportional valve,
and the difficulty in obtaining a complete, accurate and robust model of some phenomena, such as the interaction between grinder and material which is linked to temperature, chemical-physical features of the material, state of wear of the grinder, etc.,
   makes the calibration of the torque regulator complex.

Therefore, the current indirect regulation of the ground thickness through the force imparted by the hydraulic cylinder, where the control variable is the opening of the proportional valve and the controlled variable is the grinding torque, makes the grinding process inefficient.

Furthermore, considering the structure of the grinding pendulum, it is evident that the variations in the angle of inclination of the structure are directly linked to the geometry of the surface being processed.

It is obvious, in fact, that while the removal of a uniform layer of material on a perfect parallelepiped would ensure that the angle of inclination remained essentially constant throughout the entire process, the presence of surface irregularities instead introduces a variability of said angle of inclination which forces the definition of position and speed limits for the pendulum.

The main deformations which can be identified in the geometry of the products to be processed are twisting about an axis in the direction of length or width, and bending, as shown in FIG. 1.

Disadvantageously, during the execution of a grinding pass, these surface irregularities generate oscillations of the grinding pendulum which produce speed disturbances, which are one of the main factors affecting the final quality of the processing and productivity.

Therefore, the need is felt to make an innovative grinding system and a related process to overcome the aforesaid drawbacks.

### BRIEF SUMMARY

It is an object of the present invention to provide a grinding system which allows a greater efficiency of the process of grinding a surface of a semi-finished metal product in the form of a billet or slab.

It is another object of the present invention to provide a grinding system capable of grinding, while maintaining the removal thickness constant, also twisted or bent surfaces of billets or slabs while maintaining the maximum possible speed for productivity. It is a further object of the present invention to provide an efficient grinding process which allows for a compensation capable of improving speed disturbance rejection linked to the variability of the angle of inclination of the grinding pendulum.

The present invention achieves such objects and other objects, which will become apparent in the light of the present description, by means of a grinding system for grinding a surface of a metal billet or slab, the system comprising
a grinding wheel, adapted to remove in each grinding pass a respective longitudinal portion of a surface layer of the billet or slab during a relative movement between the billet, or slab, and said grinding wheel along a plane;
positioning means for the grinding wheel adapted to keep said grinding wheel in contact with the surface of the billet or slab during each grinding pass,
   wherein at least one sensor is provided, adapted to detect the profile of the longitudinal portion of surface layer to be removed during each grinding pass;
   wherein a control device is further provided adapted to memorize said profile and to control the positioning means so that the grinding wheel, during a subsequent grinding pass for removing a further longitudinal portion of said surface layer which is adjacent to the longitudinal portion removed in the previous grinding pass, moves perpendicularly to said plane following said profile detected in the previous grinding pass.

According to a further aspect of the invention, there is provided a process for grinding a metal billet or slab having at least one surface to be ground, the process being performed by means of the aforesaid grinding system and comprising the following steps:
performing a first grinding pass, by means of the grinding wheel, the billet, or slab, and said grinding wheel being in relative movement along a plane, so as to remove a longitudinal portion of a surface layer of the billet or slab;
performing at least one further grinding pass, by means of said grinding wheel, the billet, or slab, and said grinding wheel being in relative movement along said plane, so as to remove at least one further longitudinal portion of said surface layer adjacent to the longitudinal portion removed in the previous grinding pass, until completing the removal of said surface layer;
   wherein, during each grinding pass, the detection of the profile of the respective longitudinal portion of surface layer to be removed, by means of the at least one sensor, and the memorization of said profile in the control device are provided;
   and wherein the subsequent grinding passes following the first grinding pass are performed by moving the grinding wheel perpendicularly to said plane, by means of said positioning means controlled by the control device, following the profile of the respective adjacent longitudinal portion of surface layer removed during the previous grinding pass.

Advantageously, the solution of the invention allows for an optimization of the grinding based on a detection of the profile of a longitudinal portion of surface before being ground in each pass, so as to predict as much as possible the curvilinear oscillation movements of the grinding pendulum, or the vertical linear oscillation movements of the grinding wheel, in the subsequent grinding pass along a further adjacent longitudinal portion of said surface.

The solution of the invention also allows to implement a compensation capable of improving the rejection of the disturbance linked to the variability of the angle of inclination of the grinding pendulum, or simply to the variability of the height of the grinding wheel.

Profile detection can be obtained directly by means of at least one sensor, placed along the trajectory traveled by the metal product or which moves together with the grinding wheel along the trajectory traveled by said wheel, and capable of measuring the vertical distance of a point on the material with respect to a reference.

Alternatively, the detection of said profile can be obtained by means of an indirect measurement, measuring the mutual distance between the grinder, in particular a point thereof, and a fixed abutment.

In particular, the solution of the invention allows the productivity of the grinding process to be increased, by virtue of the progressive knowledge of the profile of the product to be treated, which allows the passing speed to be kept high. Considering that each surface, or side, of the slab or billet to be ground consists of a plurality of longitudinal portions, adjacent and parallel to one another, of a surface layer to be removed, detecting in each grinding pass the profile of the respective longitudinal portion of surface layer to be removed and then moving the grinding wheel following said profile, detected in the previous grinding pass, during the subsequent grinding pass to remove a further longitudinal portion of said surface layer adjacent to the longitudinal portion removed in the previous grinding pass, has surprisingly allowed to increase the productivity of the grinding process.

Further features and advantages of the invention will become more apparent in light of the detailed description of the preferred, but not exclusive embodiments.

The dependent claims describe particular embodiments of the invention.

### BRIEF DESCRIPTION OF THE DRAWINGS

The description of the invention refers to the accompanying drawings, which show non-limiting examples, in which:

FIG. 1 shows examples of deformation of a metal product: ideal (left), longitudinal twisting (center), bending (right);

FIG. 2 shows a diagram of an embodiment of a system according to the invention;

FIG. 2a shows the components of a variant of said embodiment;

FIG. 3 shows a diagram of a further embodiment of the system according to the invention;

FIGS. 4a and 4c diagrammatically show a side view of a metal product to be ground and the profile detected during a first grinding pass;

FIGS. 4b and 4d diagrammatically show the profile which will be followed by the grinding wheel in a grinding pass subsequent to said first grinding pass;

FIG. 5 shows a diagram of a variant of part of a grinding system according to the invention.

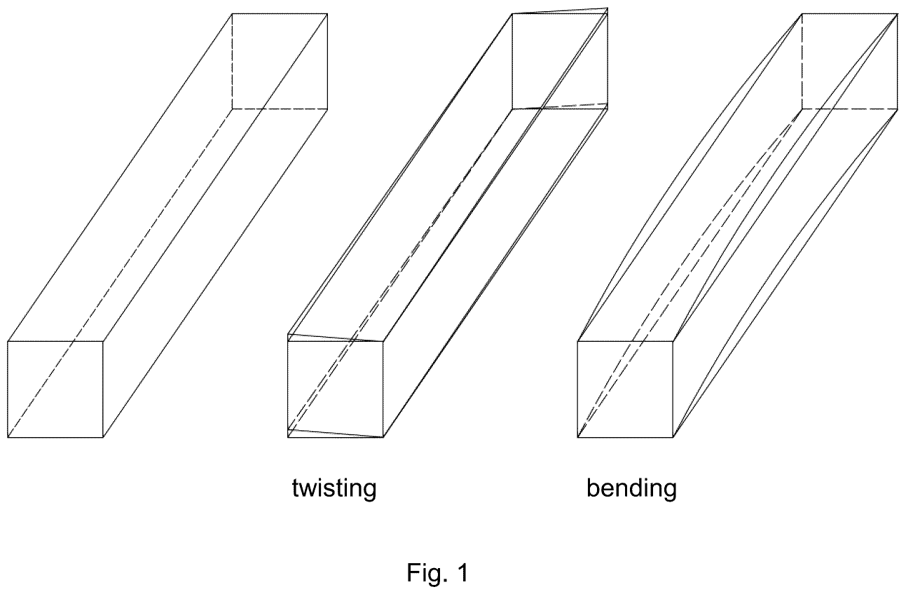

The same reference numerals in the Figures identify the same elements or components.

### DETAILED DESCRIPTION

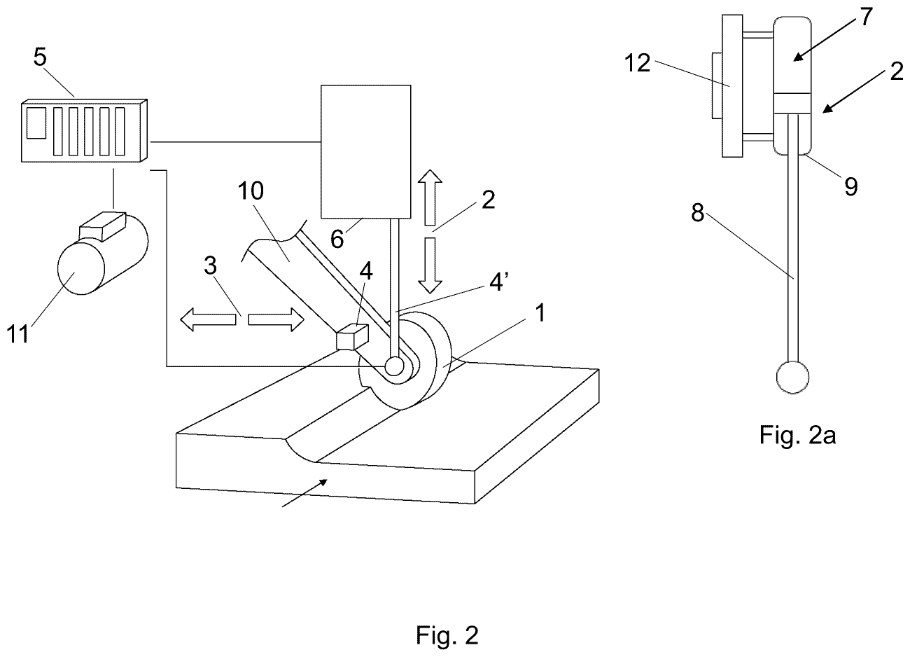

Some examples of a grinding system, forming the object of the present invention, are shown with reference to FIGS. 2-5.

In all embodiments of the invention the grinding system of a metal billet or slab, hereinafter referred to as a metal product, comprises:
a grinding wheel 1, adapted to remove in each grinding pass a respective longitudinal portion of a surface layer of the metal product during a relative movement between the metal product and grinding wheel along a plane;
positioning means for the grinding wheel 1 to keep the grinding wheel 1 in contact with the surface of the metal product during each grinding pass or during at least one first grinding pass;
at least one sensor 4, adapted to detect, during the relative movement between the metal product and the grinding wheel, along each grinding pass, the profile of the longitudinal portion of surface layer which is about to be removed;
and a control device 5 adapted to memorize said profile and configured to control the positioning means so that the grinding wheel 1, during a subsequent grinding pass for removing a further longitudinal portion of said surface layer which is adjacent to the longitudinal portion removed in the previous grinding pass, moves perpendicularly to said relative movement plane following said profile detected in the previous grinding pass.

Preferably, the positioning means comprise first positioning means 2 for moving the grinding wheel 1 purely vertically and, preferably, second positioning means 3 for moving said grinding wheel 1 purely horizontally.

The first positioning means 2 can comprise, for example, a linear actuator, such as a hydraulic or pneumatic or mechanical or electromechanical actuator.

The second positioning means 3 can comprise, for example, a further linear actuator, such as a hydraulic or pneumatic or mechanical or electromechanical actuator.

In a first embodiment of the grinding system of the invention, shown in FIG. 2, the grinding wheel 1, or simply grinder, is applied to a mechanical structure, known as a grinding pendulum, comprising at least one mechanical arm 10.

This mechanical arm 10 is pivoted on a point, called the fulcrum (not shown) and distal from the grinding wheel, which defines the oscillation axis of said mechanical arm.

The grinding wheel 1 is kept rotating by a motor 11, preferably connected to a mandrel whose shaft is aligned with the rotation axis of the grinding wheel. In this variant, the grinding wheel 1 can oscillate about said fulcrum while carrying out the grinding pass.

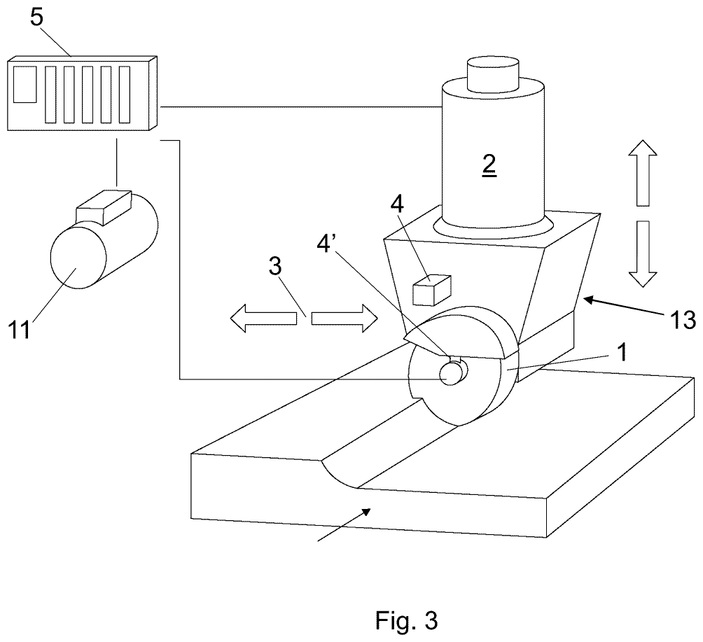

In a second embodiment of the system of the invention, shown in FIG. 3, the grinding wheel 1 is applied to a mechanical support structure 13, which can only be moved vertically.

The vertical movement of the mechanical support structure 13, and therefore of the grinding wheel 1, can be carried out by means of a linear actuator 2, for example of the electromechanical or mechanical type.

Preferably, the linear actuator 2 is an electromechanical actuator, provided with an electric motor to control the movement.

For example, the electric motor is connected to a lead screw on which a nut slides. An anti-rotation device can be provided, which allows only the linear and non-rotational movement of the nut. The nut is anchored to the mechanical support structure 13 to be moved.

In this second embodiment the grinding pendulum is not provided, and therefore the curvilinear oscillation of the grinding wheel about a fulcrum is not provided. In this variant, the grinding wheel 1 can oscillate vertically while carrying out the grinding pass.

Precision guides can be provided to guide a vertical sliding, upwards or downwards, of said mechanical support structure 13.

The grinding wheel 1, as shown in FIGS. 2-5, is preferably configured to have the rotation axis thereof parallel to the longitudinal plane of relative movement between the metal product and the grinding wheel, also called the grinding plane. In other words, the grinding wheel is arranged orthogonally with respect to a longitudinal plane defined by the metal product, so as to direct the sparks in a desired direction, for example towards a wall (not shown).

Alternatively, the grinding wheel may have the rotation axis thereof not parallel to the longitudinal plane of relative movement between the metal product and the grinding wheel, also comprising the possibility of a rotation axis of the grinding wheel substantially orthogonal to said plane.

Said at least one sensor 4 can directly or indirectly detect the profile of the longitudinal portion of surface layer which is about to be removed.

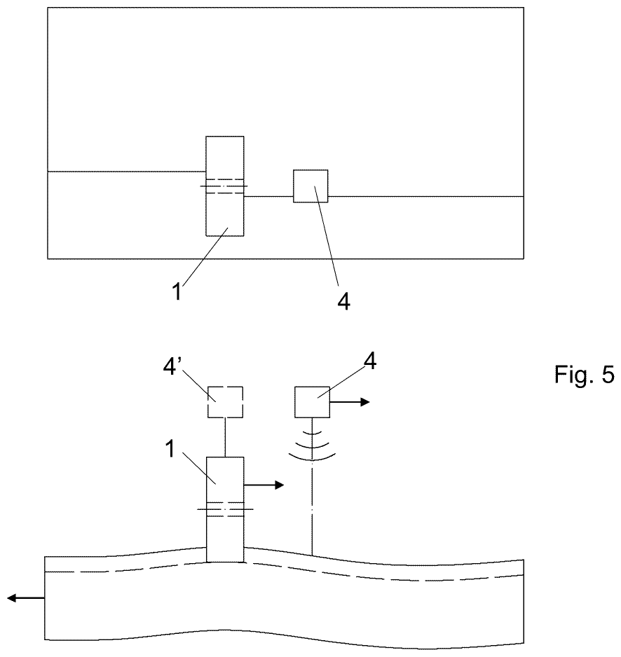

The term “directly” means that the sensor 4 (FIG. 5) directly detects the profile of the surface of the product yet to be ground. Therefore, the sensor 4 moves together with the grinding wheel 1, i.e., it can oscillate together with the grinding pendulum, or slide vertically together with the grinding wheel, during said relative movement between the wheel and the metal product, but it does not detect the position of the grinding wheel.

In this case the sensor 4 can be, for example, at least one position transducer, such as a touch probe or a laser sensor or a Linear Variable Differential Transformer sensor (LVDT).

Such position transducer 4 can be integrated into, or connected to, a bearing structure of the grinding wheel 1, for example to the mechanical arm 10 of the grinding pendulum (FIG. 2) or to the mechanical support structure 13 which can be moved vertically (FIG. 3).

The term “indirectly” means that the sensor 4′ (FIGS. 2, 3 and 5), alternative to the sensor 4, detects the position of the grinding wheel 1, which, in turn, remaining in contact with the surface of the product to be ground during said relative movement, moves following the trend of the profile of said surface. Therefore, the surface profile is detected indirectly.

Preferably, in this case, the at least one sensor 4′ is at least one position transducer, adapted to directly or indirectly measure the distance of the grinding wheel 1, and preferably of the rotation axis thereof, with respect to a fixed abutment, preferably along a vertical plane.

In the variant of FIG. 2 the grinding system does not include the well-known hydraulic system, consisting of a double-acting hydraulic cylinder and a proportional valve, and the fixed abutment is indicated with reference numeral 6.

In this variant, a direct measurement of the distance of the grinding wheel 1 with respect to the fixed abutment 6 can be performed by means of at least one position transducer, such as, for example, at least one touch probe 4′ or a laser sensor or a Linear Variable Differential Transformer sensor (LVDT).

Such position transducer 4′ can be integrated into, or connected to, a bearing structure of the grinding wheel 1 (FIGS. 2 and 3), so it moves together with the grinding wheel 1.

In the variant of FIG. 2a, the grinding system instead includes the hydraulic system, consisting of a double-acting hydraulic cylinder 7 and a proportional valve 12, and the fixed abutment is represented by the chamber 9 of the cylinder, for example by the lower external surface of the chamber. In this case, the position transducer is the hydraulic actuator 7 itself. Alternatively, the position transducer can be a pneumatic or mechanical or electromechanical actuator, i.e., an alternative linear actuator.

The distance between the grinding wheel 1 and the chamber 9 of the actuator is measured indirectly by means of a pressure sensor (not shown) capable of detecting the value of a pressure exerted on the stem 8 of the hydraulic or pneumatic actuator corresponding to the reaction force between the grinding wheel 1 and the surface of the metal product.

In the case of a mechanical or electromechanical actuator, the distance between the grinding wheel and a fixed point provided on the actuator is measured indirectly by means of a pressure sensor adapted to detect the value of a pressure, corresponding to said reaction force and exerted on the transmitting element for transmitting the linear movement of the actuator, such as, for example, a nut, which is anchored to a support structure 13 of the wheel.

A grinding process according to the invention is described below, performed by means of the grinding system described above.

The grinding process advantageously comprises the following steps:
performing a first grinding pass, by means of the grinding wheel 1; the metal product, in the form of billet or slab, and said grinding wheel being in relative movement along a plane, so as to remove a first longitudinal portion of a surface layer of the metal product;
performing at least one further grinding pass, by means of said grinding wheel 1, the metal product and said grinding wheel being in relative movement along said plane, so as to remove at least one further longitudinal portion of surface layer adjacent to the longitudinal portion removed in the previous grinding pass, until completing the removal of said surface layer;
detecting, during said relative movement in each grinding pass, by means of the at least one sensor 4, the profile of the respective longitudinal portion of surface layer which is about to be removed, and memorizing said profile in the control device 5;
performing the subsequent grinding passes following the first grinding pass by moving the grinding wheel 1 perpendicularly to said plane, by means of the positioning means 2 controlled by the control device 5, following the profile of the respective adjacent longitudinal portion of surface layer removed during the previous grinding pass.

Preferably, a removal thickness is kept constant in the grinding passes. In a first variant of the process of the invention, during each grinding pass the metal product advances along said plane with respect to the grinding wheel, which does not move along said plane but only along a plane perpendicular to said plane.

In a second variant of the process of the invention, during each grinding pass the grinding wheel also advances along said plane with respect to the metal product, which remains stationary.

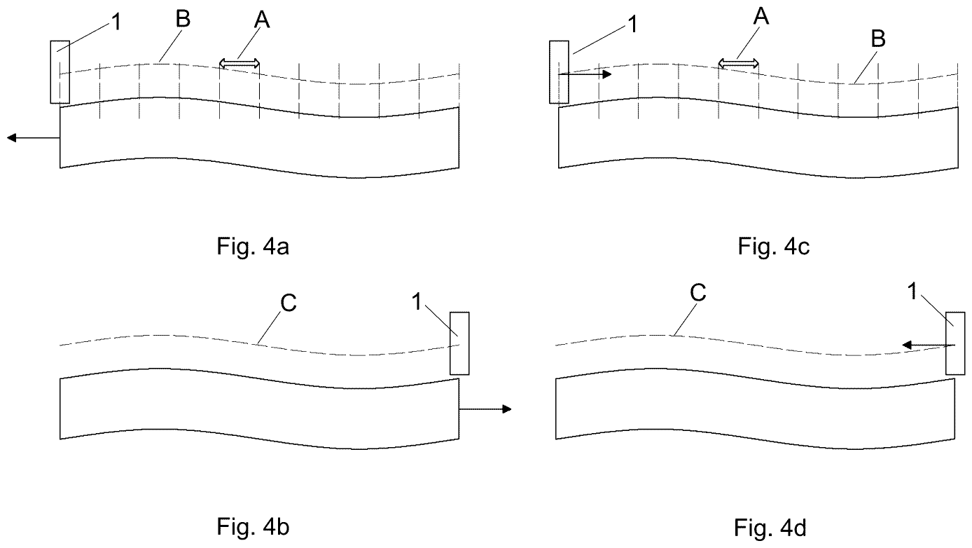

In the first variant of the process, the metal product can advance for a grinding pass along said plane according to a first longitudinal direction and, once the grinding pass of the respective longitudinal portion of surface layer to be removed has been completed, said metal product can advance for the subsequent grinding pass of a further adjacent longitudinal portion according to a second longitudinal direction, parallel but opposite to the first direction (FIGS. 4a and 4b). For the further subsequent grinding pass of a new further adjacent longitudinal portion, the metal product can advance again according to the first longitudinal direction, and so on. In this case, at least two sensors 4 or 4′ are provided, of which a first sensor arranged at a first side of the grinding wheel, and a second sensor arranged at a second side of the grinding wheel, opposite to the first side.

By way of explanation, FIG. 4a shows a sampling distance A for the detection by the sensor. Letter B indicates the profile of the respective longitudinal portion of surface layer removed, for example, in a first grinding pass, as recorded during the advancement of the product.

In this first variant, in the subsequent grinding passes following the first grinding pass, the grinding wheel 1 is moved perpendicularly to the plane along which the advancement of the metal product is provided, following a profile which mirrors the profile of the respective adjacent longitudinal portion of surface layer removed in the previous grinding pass, as recorded during the advancement of the product but in the opposite direction.

In FIG. 4b, the letter C indicates the profile that will be followed, for example, by the grinding wheel 1 in a second grinding pass.

Alternatively, the metal product can advance for each grinding pass, each grinding pass relating to a respective longitudinal portion of surface layer to be removed, always in the same direction (FIG. 4a). This, however, requires the metal product to be brought back to the start position of the grinding pass at the end of each pass. In this manner, it is sufficient to provide a single sensor 4 or 4′ at a single side of the grinding wheel.

In this case, in the subsequent grinding passes following the first grinding pass, the grinding wheel 1 is moved perpendicularly to the advancement plane of the metal product, following the profile of the respective adjacent longitudinal portion removed in the previous grinding pass, always in the same direction, as recorded during the advancement of the product.

Similarly, in the second variant of the process, the grinding wheel 1 can advance for a grinding pass along said plane according to a first longitudinal direction and, once the grinding pass of the respective longitudinal portion of surface layer to be removed has been completed, said grinding wheel can advance for the subsequent grinding pass of a further adjacent longitudinal portion according to a second longitudinal direction, parallel but opposite to the first direction (FIGS. 4c and 4d). For the further subsequent grinding pass of a new further adjacent longitudinal portion, the grinding wheel can advance again according to the first longitudinal direction, and so on. In this case, at least two sensors 4 or 4′ are provided, of which a first sensor arranged at a first side of the grinding wheel, and a second sensor arranged at a second side of the grinding wheel, opposite to the first side.

By way of explanation, FIG. 4c shows a sampling distance A for the detection by the sensor. Letter B indicates the profile of the respective longitudinal portion of surface layer removed, for example, in a first grinding pass, as recorded during the advancement of the product.

In this second variant, in the subsequent grinding passes following the first grinding pass, the grinding wheel 1 is also moved perpendicularly to the plane along which the advancement of the grinding wheel itself is provided, following a profile which mirrors the profile of the respective adjacent longitudinal portion of surface layer removed in the previous grinding pass, as recorded during the advancement of the grinding wheel but in the opposite direction.

In FIG. 4d, the letter C indicates the profile that will be followed, for example, by the grinding wheel 1 in a second grinding pass.

Alternatively, the grinding wheel can advance for each grinding pass, each grinding pass relating to a respective longitudinal portion of surface layer to be removed, always in the same direction (FIG. 4c). This, however, requires the grinding wheel to be brought back to the start position of the grinding pass at the end of each pass. In this manner, it is sufficient to provide a single sensor 4 or 4′ at a single side of the grinding wheel.

In this case, in the subsequent grinding passes following the first grinding pass, the grinding wheel 1 is moved perpendicularly to the advancement plane of the grinding wheel itself, following the profile of the respective adjacent longitudinal portion removed in the previous grinding pass, always in the same direction, as recorded during the advancement of the wheel.

A third variant of the process of the invention is not excluded, wherein during each grinding pass both the metal product and the grinding wheel advance along said plane, although along directions opposite to each other (FIG. 5).

Preferably, between a grinding pass and the subsequent one, the grinding wheel 1 is moved, transverse to said longitudinal directions, to pass from a position at the longitudinal portion just ground to a position at a further adjacent longitudinal portion of said surface layer to be ground, for example by means of the positioning means 3.

Alternatively, between a grinding pass and the subsequent one, the metal product is moved, transversally to said longitudinal directions, by means of a respective means for positioning the metal product, to pass from a position, in which the longitudinal portion of surface layer which has just been ground is at the grinding wheel, to a position in which a further longitudinal portion to be ground, adjacent to said portion which has just been ground, is at said grinding wheel.

Preferably, in all variants, the first grinding pass is performed with a first speed of rotation of the grinding wheel 1, which is variable according to detected changes in the load torque (contact torque) between the grinding wheel and the surface of the metal product; while, during the subsequent grinding passes following the first grinding pass, the grinding wheel 1 follows the trend of the profile of the longitudinal portion of surface layer removed in the previous grinding pass and said subsequent grinding passes are performed with a second speed of rotation of the grinding wheel 1 which is substantially more constant, as long as the trend of the profile of the longitudinal portion of surface layer being removed corresponds to the trend of the profile of the adjacent longitudinal portion of surface layer removed in the previous grinding pass.

In other words, the first grinding pass is performed at an advancement speed of the metal product or of the grinding wheel, along the relative movement plane or grinding plane, which is potentially less than the possible theoretical speed, said advancement speed being a function of the speed of rotation of the grinding wheel 1 which can vary depending on detected changes in the torque acting between the grinding wheel and the surface of the metal product. Therefore, there can be decelerations (in the event of high contact torque, and therefore excessive removal with respect to the pre-set removal thickness) or accelerations (in the event of low contact torque, and therefore insufficient removal).

In subsequent passes, instead, advantageously, it is possible to proceed by having a prior indication of the profile the grinding wheel must follow, whereby it is possible to proceed with a more constant and higher speed, increasing the corresponding productivity. In fact, the grinding pass can be performed with a greater advancement speed of the metal product or of the grinding wheel along the relative movement plane.

In the event that in a subsequent grinding pass new depressions or bumps are found along the surface profile of the longitudinal portion of surface layer being removed, which were not present in the adjacent longitudinal portion previously removed, and therefore should the contact torque vary, leading to an alteration in the speed of rotation of the grinding wheel, this new detected profile will be followed in the further subsequent pass.

1. A grinding system for grinding a surface of a metal billet or slab, the system comprising:
a grinding wheel, adapted to remove in each grinding pass a respective longitudinal portion of a surface layer of the billet or slab during a relative movement between the billet, or slab, and said grinding wheel along a plane;
positioning means for the grinding wheel adapted to keep said grinding wheel in contact with the surface of the billet or slab during each grinding pass,
at least one sensor, adapted to detect a profile of the longitudinal portion of surface layer to be removed during each grinding pass;
a control device adapted to memorize said profile
characterized in that
said control device is configured to control the positioning means so that the grinding wheel, during a subsequent grinding pass for removing a further longitudinal portion of said surface layer which is adjacent to the longitudinal portion removed in a previous grinding pass, moves perpendicularly to said plane following said profile detected in the previous grinding pass.

2. A system according to claim 1, wherein the positioning means comprise first positioning means for moving the grinding wheel vertically and, preferably, second positioning means for moving said grinding wheel horizontally.

3. A system according to claim 1, wherein said at least one sensor is a position transducer, configured to directly detect the profile of said longitudinal portion of surface layer to be removed or to indirectly detect said profile by means of a direct or indirect measurement of a distance of the grinding wheel, and preferably of a rotation axis thereof, with respect to a fixed abutment.

4. A system according to claim 1, wherein said at least one sensor is a position transducer, such as a touch probe, or a laser sensor, or a Linear Variable Differential Transformer sensor (LVDT), preferably integrated into, or connected to, a bearing structure of the grinding wheel (1).

5. A system according to claim 4, wherein at least two sensors are provided, of which a first sensor arranged at a first side of the grinding wheel, and a second sensor arranged at a second side of the grinding wheel, opposite to the first side; or wherein only one sensor is provided at only one side of the grinding wheel.

6. A system according to claim 4, wherein said bearing structure of the grinding wheel comprises at least one mechanical arm of a grinding pendulum or is a mechanical support structure vertically moveable.

7. A system according to claim 3, wherein, in the case of a position transducer configured to indirectly measure the distance of the grinding wheel with respect to the fixed abutment, said position transducer is a mechanical or electromechanical actuator, possibly defining the first positioning means,
wherein a pressure sensor is provided, adapted to detect a value of a pressure exerted on a transmitting element for transmitting a linear movement to the grinding wheel, said pressure corresponding to a contact force between the grinding wheel and the surface of the billet or slab, whereby the distance between the grinding wheel and the fixed abutment is measured indirectly.

8. A system according to claim 3, wherein, in the case of a position transducer configured to indirectly detect the distance of the grinding wheel (1) with respect to the fixed abutment (6, 9), said position transducer is a hydraulic or pneumatic actuator (7), possibly defining the first positioning means (2),
wherein a pressure sensor is provided, adapted to detect a value of a pressure exerted on a stem (8) of said actuator, said pressure corresponding to a contact force between the grinding wheel (1) and the surface of the billet or slab, whereby the distance between the grinding wheel (1) and a chamber (9) of said actuator is measured indirectly.

9. A process of grinding a metal billet or slab having at least one surface to be ground, the process being performed by means of a grinding system according to claim 1 and comprising the following steps:
performing a first grinding pass, by means of the grinding wheel, the billet, or slab, and said grinding wheel being in relative movement along a plane, so as to remove a longitudinal portion of a surface layer of the billet or slab;
performing at least one further grinding pass, by means of said grinding wheel, the billet, or slab, and said grinding wheel being in relative movement along said plane, so as to remove at least one further longitudinal portion of said surface layer adjacent to the longitudinal portion removed in the previous grinding pass, until completing a removal of said surface layer;
wherein, during each grinding pass, a detection of the profile of a respective longitudinal portion of surface layer to be removed, by means of the at least one sensor, and a memorization of said profile in the control device are provided;
and wherein subsequent grinding passes following the first grinding pass are performed by moving the grinding wheel perpendicularly to said plane, by means of said positioning means controlled by the control device, following the profile of a respective adjacent longitudinal portion of surface layer removed during the previous grinding pass.

10. A process according to claim 9, wherein the first grinding pass is performed with a first speed of rotation of the grinding wheel, which is variable according to detected changes in a load torque between the grinding wheel and the surface of the billet or slab; and wherein, during the subsequent grinding passes following the first grinding pass, the grinding wheel follows a trend of the profile of the longitudinal portion of surface layer removed in the previous grinding pass and said subsequent grinding passes are performed with a second speed of rotation of the grinding wheel which is substantially constant as long as the trend of a profile of the longitudinal portion of surface layer being removed is equal to the trend of the profile of the longitudinal portion of surface layer removed in the previous grinding pass.

11. A process according to claim 9, wherein the relative movement between the billet, or slab, and the grinding wheel along said plane is defined by an advancement of the billet or slab along said plane with respect to the grinding wheel, or by an advancement of the grinding wheel along said plane with respect to the billet or slab, or by an advancement of both the billet, or slab, and the grinding wheel in directions opposite to each other.

12. A process according to claim 9, wherein, between a grinding pass and the subsequent one, a movement of the grinding wheel is provided to pass from a position at a longitudinal portion of the surface layer which has just been ground to a position at a further adjacent longitudinal portion of said surface layer to be ground.

13. A process according to claim 9, wherein, between a grinding pass and the subsequent one, a movement of the billet or slab is provided to pass from a position, in which the longitudinal portion of the surface layer which has just been ground is at the grinding wheel, to a position in which a further longitudinal portion to be ground, adjacent to said longitudinal portion which has just been ground, is at said grinding wheel.

14. A process according to claim 10, wherein, in the event that, in a subsequent grinding pass, depressions or bumps are found, along a further surface profile of the longitudinal portion of surface layer being removed, which were not present in an adjacent longitudinal portion previously removed, and therefore should the load torque vary, leading to an alteration of the speed of rotation of the grinding wheel, a further subsequent grinding pass along a new adjacent longitudinal portion is carried out by moving the grinding wheel perpendicularly to said plane, by means of said positioning means, following said further surface profile detected by the at least one sensor.
